(19) United States
(12) Patent Application Publication
(10) Pub. No.: US 2024/0082875 A1
(43) Pub. Date: Mar. 14, 2024

(54) STAINED WOOD PRODUCT AND METHOD OF STAINING A WOOD PRODUCT

(71) Applicant: RH US, LLC, Corte Madera, CA (US)

(72) Inventor: Gary Friedman, Belvedere, CA (US)

(21) Appl. No.: 18/463,758

(22) Filed: Sep. 8, 2023

Related U.S. Application Data
(60) Provisional application No. 63/404,636, filed on Sep. 8, 2022.

(51) Int. Cl. B05D 7/08; B05D 3/00; B05D 3/12; B05D 7/00

(52) U.S. Cl. CPC B05D 7/08; B05D 3/007; B05D 3/12; B05D 7/574; B05D 2502/00; B05D 2503/00

(57) ABSTRACT

A method of staining a wood product includes sanding a surface of the wood product, wire brushing the surface to expose open grains in the wood product, applying a first coat of a toner to the surface of the wood product that penetrates into the open grains of the wood product, applying a second coat of the toner to the surface of the wood product after applying the first coat, applying a glaze to the surface of the wood product after applying the second coat of the toner, and applying a top coat to the surface of the wood product after applying the glaze.

### CROSS-REFERENCE TO RELATED APPLICATION(S)

The present application claims priority to and the benefit of U.S. Provisional Patent Application No. 63/404,636, filed Sep. 8, 2022, the entire content of which is incorporated herein by reference.

### BACKGROUND

### 1. Field

The present disclosure relates to various embodiments of a stained wood product and methods of staining a wood product.

### 2. Description of Related Art

A variety of different types of wood products exist, including natural wood products (e.g., softwood and hardwood products) and engineered wood products (e.g., plywood, particleboard, oriented strand board, laminate wood, structural composite board, medium-density fiberboard, cross-laminated timber, and glued-laminated timber (glulam) products). These existing wood products may be used in structural components or as surface treatments to structural components for aesthetic purposes.

### SUMMARY

The present disclosure relates to various embodiments of a method of staining a wood product. In one embodiment, the method includes sanding a surface of the wood product, wire brushing the surface to expose open grains in the wood product, applying a first coat of a toner to the surface of the wood product that penetrates into the open grains of the wood product, applying a second coat of the toner to the surface of the wood product after applying the first coat, applying a glaze to the surface of the wood product after applying the second coat of the toner, and applying a top coat to the surface of the wood product after applying the glaze.

The method may also include drying the first coat of toner for approximately 45 minutes before applying the second coat of the toner.

The method may further include drying the second coat of toner for approximately 45 minutes before applying the glaze.

The method may also include sanding the second coat of the toner before applying the glaze.

The method may further include drying the glaze for a duration in a range from 4 hours to 8 hours before applying the top coat.

The method may further include post-processing the glaze after drying the glaze. Post-processing of the glaze may include rubbing the glaze with an abrasive.

Applying the glaze may include partially removing the glaze in a cross-grain direction of the wood product and leaving the glaze in the open grains of the wood product, allowing the glaze to set, re-applying the glaze, and removing excess of the glaze.

Sanding the surface of the wood product may utilize a 150 grit sandpaper.

The present disclosure also relates to various embodiments of a stained wood product. In one embodiment, the stained wood product includes a wood veneer having open grains exposed on a first surface of the wood veneer, a first toner coating on the first surface of the wood veneer and in the open grains, a second toner coating on the first toner coating, a glaze on the second toner coating, and a topcoat on the glaze.

The stained wood product may be incorporated into any structure, such as the wall of a hotel or an aircraft.

When the stained wood product is incorporated into an aircraft, the topcoat may include a fire retardant. In one embodiment, when the stained wood product is incorporated into an aircraft, the topcoat may be a 4-part acrylic polyurethane topcoat including a fire retardant agent, a reducer, a low gloss clearcoat, and a low gloss clearcoat activator.

Each of the first toner coating and the second toner coating may include toluene, butyl acetate, acetone, isobutyl alcohol, ethyl alcohol, ethyl acetate, methanol, and propyl alcohol. Each of the first toner coating and the second toner coating may further include n-butyl alcohol, isopropyl alcohol, and ethylbenzene.

The glaze may include an aromatic hydrocarbon mixture having more than nine carbons (>C9), isobutyl alcohol, naphthalene, n-butyl alcohol, and titanium dioxide.

The topcoat may include a first component, a catalyst, and a thinner.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIGS. 1A-1B are a perspective view and a cross-sectional view, respectively, of a stained wood product according to one embodiment of the present disclosure; and

FIG. 2 is a flowchart depicting tasks of a method of staining a wood product according to one embodiment of the present disclosure.

### DETAILED DESCRIPTION

The present disclosure relates to various embodiments of a stained wood product and a method of treating and staining a wood product. In one or more embodiments, the stained wood product includes a wood veneer having a series of open grains (open cell grains) that are exposed on one surface of the wood veneer, and a series of coatings (e.g., a toner, a glazing, and a topcoat) on the surface of the wood veneer at which the open grains are exposed. In one or more embodiments, at least the first toner coat penetrates into the open grains of the wood veneer. Additionally, in one or more embodiments, the stained wood product includes a durable topcoat configured to mitigate against damage to the wood product. The stained wood product may be used in dwellings (e.g., an apartment or other living quarters), commercial buildings (e.g., on the walls and/or the ceiling of a hotel room or an office building), and/or transportation vehicles (e.g., on the walls, the ceiling, and/or the bulkheads of an aircraft cabin, the walls of an aircraft lavatory, and/or the walls of an aircraft galley).

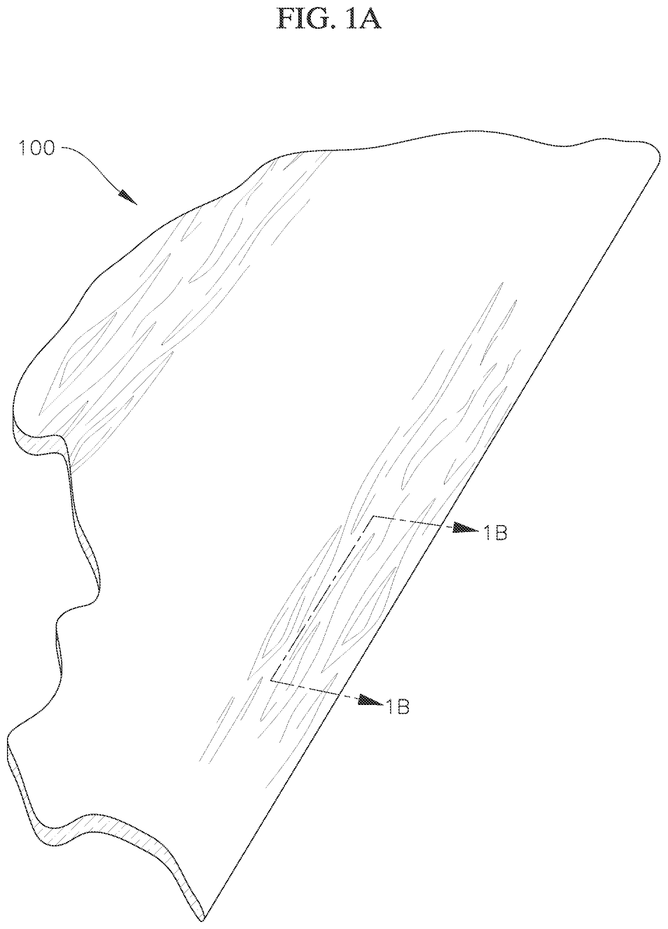

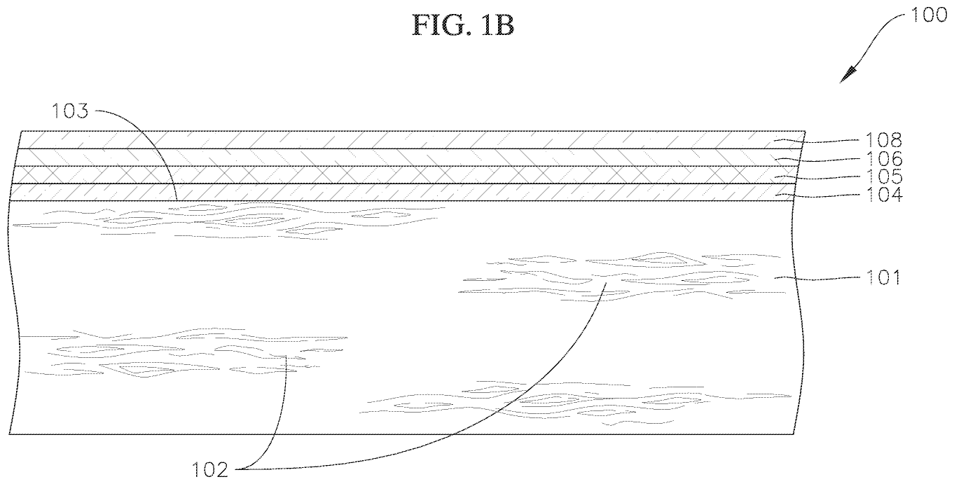

With reference now to FIGS. 1A-1B, a stained wood product 100 according to one embodiment of the present disclosure includes a wood veneer layer 101. The wood veneer layer 101 includes a series of grains or fibers 102. In the illustrated embodiment, the fibers of the wood veneer layer 101 are straight and parallel (or substantially straight and parallel) to each other, although in one or more embodiments the fibers 102 of the wood veneer layer 101 may have any other suitable configuration or pattern (e.g., the fibers 102 of the wood veneer layer 101 may be wavy or irregular). Additionally, in the illustrated embodiment, the grains 102 of the wood veneer layer 101 are open at an upper surface 103 of the wood veneer layer 101 (i.e., open grains 102 are exposed at the upper surface 103 of the wood veneer layer 101).

In the illustrated embodiment, the stained wood product 100 includes a first toner coating or layer 104 on the upper surface 103 of the wood veneer layer 101. In one or more embodiments, the first toner coating 104 may penetrate (at least partially) into the open grains 102 that are exposed on the upper surface 103 of the wood veneer layer 101. In one or more embodiments, the first toner coating 104 may be a combination of a clear finish and pigmentation. In one or more embodiments in which the finish is an oil-based finish, the first toner coating 104 may be a combination of the oil-based finish, a thinner, and pigmentation. In one or more embodiments, the first toner coating 104 may be a combination of toluene (approximately 23% to approximately 39% by weight), butyl acetate (approximately 8% to approximately 19% by weight), acetone (approximately 7% to approximately 16% by weight), isobutyl alcohol (approximately 5% to approximately 11% by weight), ethyl alcohol (approximately 5% to approximately 11% by weight), ethyl acetate (approximately 5% to approximately 11% by weight), methanol (approximately 4% to approximately 10% by weight), propyl alcohol (approximately 4% to approximately 10% by weight), n-butyl alcohol (approximately 1.3% to approximately 3% by weight), isopropyl alcohol (approximately 1.3% to approximately 3% by weight), and ethylbenzene (approximately 0.1% to approximately 1.0% by weight). Additionally, in the illustrated embodiment, the stained wood product 100 includes a second toner coating or layer 105 on the first toner coating 104. The second toner coating layer 105 may have the same or substantially the same chemical composition as the first toner coating layer 104 (e.g., the second toner coating layer 105 may include a combination of a clear finish and pigmentation). Although in the illustrated embodiment the stained wood product 100 includes two toner coating layers 104, 105, in one or more embodiments, the stained wood product 100 may include any other suitable number of toner coating layers, such as three or more toner coating layers.

In the illustrated embodiment, the stained wood product 100 also includes a glazing (or glaze layer) 106 on the uppermost toner coating layer (e.g., the second toner coating 105). In one or more embodiments, the glazing 106 may include an epoxy-polyamide and one or more pigments (e.g., titanium dioxide, calcium carbonate, and/or color pigments). In one or more embodiments, the glazing (or glaze layer) 106 may be a combination of an aromatic hydrocarbon mixture having greater than nine carbons (>C9) (approximately 31% to approximately 52% by weight), isobutyl alcohol (approximately 12% to approximately 27% by weight), naphthalene (approximately 1.7% to approximately 4% by weight), n-butyl alcohol (approximately 1.7% to approximately 4% by weight), titanium dioxide (approximately 0.2% to approximately 3% by weight), cumene (approximately 0.1% to approximately 1.8% by weight), n-methyl-2-pyrrolidone (approximately 0.1% to approximately 1.8% by weight), silica (amorphous) (approximately 0.0% to approximately 0.4% by weight), a Stoddard solvent (CAS No. 8052-41-3) (i.e., a mixture of hydrocarbons comprising at least 65% C₁₀ or higher hydrocarbons) (approximately 0.0% to approximately 0.4% by weight), and aliphatic (light hydrocarbon solvent) (approximately 0.0% to approximately 0.4% by weight).

Additionally, in the illustrated embodiment, the stained wood product 100 includes a topcoat 107 on the glaze layer 106. The topcoat layer 107 is durable and configured to mitigate against damage to the stained wood product 100. The topcoat 107 may be clear or the topcoat 107 may include pigmentation. For example, in one or more embodiments, the topcoat 107 may include a white pigment (e.g., an “eggshell” colored topcoat 107). In one or more embodiments, the topcoat 107 may be fireproof or at least fire retardant (i.e., the topcoat 107 may include a fire retardant agent). In one or more embodiments, the topcoat 107 may be a 4-part acrylic polyurethane topcoat. For example, in one or more embodiments, the fire retardant topcoat 107 may include a fire retardant agent (e.g., triphenyl phosphate (CAS No. 115-86-6) (approximately 2.5% to approximately 10%)) mixed with a reducer (e.g., acetone (CAS No. 67-64-1) (approximately 50% to less than approximately 70%) and parachlorobenzotriflouride (CAS No. 98-56-6) (approximately 30% to less than approximately 50%)), a low gloss clearcoat (e.g., parachlorobenzotriflouride (CAS No. 98-56-6) (approximately 50% to less than approximately 70%), acetone (CAS No. 67-64-1) (approximately 10% to approximately less than 30%), methyl n-amyl ketone (CAS No. 110-43-0) (approximately 5% to less than approximately 10%), silica, amorphous, precipitated and gel (CAS No. 112926-00-8) (approximately 5% to less than approximately 10%), trimethyl benzene (CAS No. 25551-13-7) (approximately 1% to less than approximately 5%), trimethyl benzene (CAS No. 95-63-6) (approximately 1% to less than approximately 5%), 2,6 dimethyl-4-heptanone (CAS No. 108-83-8) (approximately 0% to less than approximately 1.5%), bis (1,2,2,6,6-pentamethyl-4-piperidinyl) sebacate (CAS No. 41556-26-7) (approximately 0% to less than approximately 1.5%), dibutyltin dilaurate (CAS No. 77-58-7) (approximately 0% to less than approximately 1.5%), ethylbenzene (CAS No. 100-41-4) (approximately 0% to less than approximately 1.5%), isopropyl benzene (CAS No. 98-82-8) (approximately 0% to less than approximately 1.5%), styrene (CAS No. 100-42-5) (approximately 0% to less than approximately 1.5%), and xylene (CAS No. 1330-20-7) (approximately 0% to less than approximately 1.5%)), and a low gloss clearcoat activator (e.g., hexamethylene diisocyanate (CAS No. 28182-81-2) (approximately 40% to less than approximately 60%), parachlorobenzotrifluoride (CAS No. 98-56-6) (approximately 40% to less than approximately 60%), and methyl isobutyl ketone (CAS No. 108-10-1) (approximately 5% to less than approximately 10%)). In one or more embodiments, the topcoat 107 may include 100 parts by volume of a first component, such as a clear matt sheen acrylic top coat (e.g., n-butyl acetate (approximately 25%-approximately 48%); toluene (approximately 12.5%-approximately 20%); butanone (approximately 9.9%-approximately 12.5%); xylene [isomer mixture] (approximately 7%-approximately 9.9%); 4-methylpentan-2-one (approximately 3%-approximately 5%); ethylbenzene (approximately 1%-approximately 2%); ethyl acetate (approximately 1%-approximately 2%); methyl 2-methylprop-2-enoate (approximately 0.5%-approximately 1%); dibutyltin dilaurate (approximately 0.2%-approximately 0.25%); 1-ethylpyrrolidin-2-one (approximately 0.1%-approximately 0.2%)), 20 parts by volume of a catalyst, such as a non-yellowing hardener (e.g., >=25%-<48% Hexamethylene diisocyanate, oligomers; >=20%-<25% ethyl acetate; >=12.5%-<20% butanone; >=9.9%-<12.5% sec-butyl acetate; >=7%-<9.9% n-butyl acetate; and >=5%-<7% 4-methylpentan-2-one; isobutyl methyl ketone), and 20 parts by volume of a thinner (e.g., n-Butyl acetate (CAS No. 123-86-4) (approximately 60% to approximately 70% by weight) and 2-Pentanone, 4-methyl (CAS No. 108-10-1) (approximately 30% to approximately 40%); or butyl acetate (normal) (CAS No. 123-86-4) (approximately 68% to approximately 72% by weight) and methyl isobutyl ketone (CAS No. 108-10-1) (approximately 28% to approximately 32% by weight)).

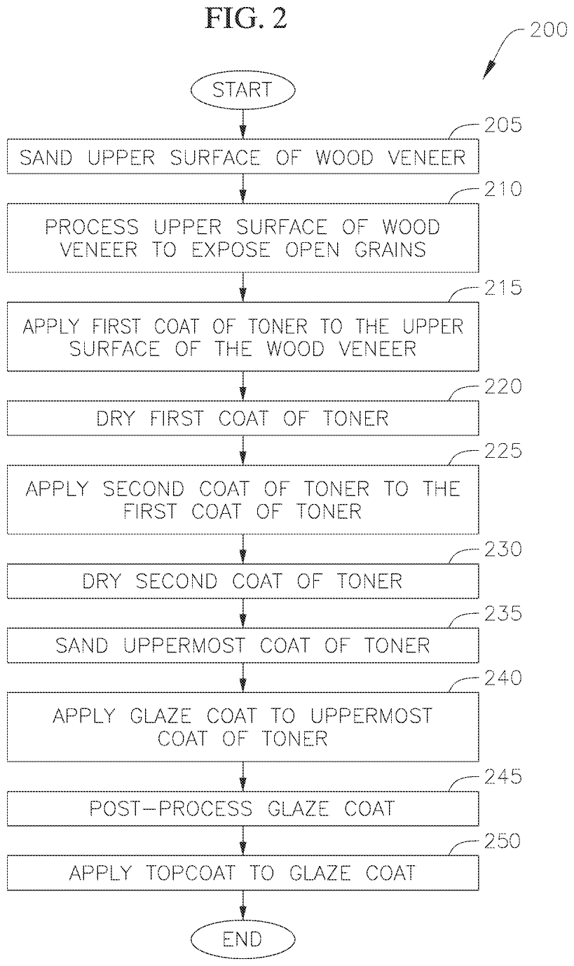

FIG. 2 is a flowchart depicting tasks of a method 200 of staining a wood product according to one embodiment of the present disclosure to form a stained wood product (e.g., the embodiment of the stained wood product 100 described above with reference to FIGS. 1A-1B). In the illustrated embodiment, the method 200 includes a task 205 of sanding an upper surface of a wood veneer product. In one or more embodiments, the task of 210 sanding the upper surface of the wood veneer product may be performed utilizing sandpaper having any suitable grid, such as 150 grit.

In the illustrated embodiment, the method 200 also includes a task 210 of processing the upper surface of the wood veneer to expose open grains of the wood veneer on the upper surface. The task 210 of processing the upper surface of the wood veneer to expose open grains may be performed by any suitable process or processes, such as by wire brushing the upper surface of the wood veneer. Wood dust generated in task 210 and/or task 205 may be blown off the wood product with compressed air.

In the Illustrated embodiment, the method 200 also includes a task 215 of applying a first coat of toner on the upper surface of the wood veneer. The task 215 of applying the first coat of toner may be performed in any suitable manner, such as by spraying the toner on the upper surface of the wood veneer. In one or more embodiments, during or following the task 215 of applying the first coat of toner on the upper surface of the wood veneer, the toner may flow or otherwise penetration (at least partially) into the open grains of the wood veneer. The toner applied in task 215 may have any suitable composition. In one or more embodiments, the toner applied in task 215 may be a combination of a clear finish and pigmentation. In one or more embodiments in which the finish is an oil-based finish, the toner applied in task 215 may be a combination of the oil-based finish, a thinner, and pigmentation. In one or more embodiments, the toner applied in task 215 may be a combination of toluene (approximately 23% to approximately 39% by weight), butyl acetate (approximately 8% to approximately 19% by weight), acetone (approximately 7% to approximately 16% by weight), isobutyl alcohol (approximately 5% to approximately 11% by weight), ethyl alcohol (approximately 5% to approximately 11% by weight), ethyl acetate (approximately 5% to approximately 11% by weight), methanol (approximately 4% to approximately 10% by weight), propyl alcohol (approximately 4% to approximately 10% by weight), n-butyl alcohol (approximately 1.3% to approximately 3% by weight), isopropyl alcohol (approximately 1.3% to approximately 3% by weight), and ethylbenzene (approximately 0.1% to approximately 1.0% by weight).

In the illustrated embodiment, the method 200 also includes a task 220 of drying the first coat of toner applied in task 215. In one or more embodiments, the task 220 of drying the first coat of toner may be performed by air drying the first coat of toner (i.e., drying the first coat of toner at ambient conditions) for a duration in the range from approximately 30 minutes to approximately 60 minutes). In one embodiment, the task 220 of drying the first coat of toner may be performed by air drying for approximately 45 minutes.

In the illustrated embodiment, the method 200 also includes a task 225 of applying a second coat of toner on the first coat of toner after it has been dried in task 220. The task 225 of applying the second coat of toner may be performed in any suitable manner, such as by spraying the toner on the upper surface of the first coat of toner. The toner applied in task 225 may be the same or substantially the same composition as the toner applied in task 215. In one or more embodiments, the toner applied in task 225 may be different than the composition of the toner applied in task 215.

In the illustrated embodiment, the method 200 also includes a task 230 of drying the second coat of toner applied in task 225. In one or more embodiments, the task 230 of drying the second coat of toner may be performed by air drying the second coat of toner (i.e., drying the second coat of toner at ambient conditions) for a duration in the range from approximately 30 minutes to approximately 60 minutes). In one embodiment, the task 230 of drying the second coat of toner may be performed by air drying for approximately 45 minutes. In one or more embodiments, the method 200 may include tasks of applying any other suitable number of coatings of toner, such as three or more coatings of toner.

In the illustrated embodiment, the method also includes a task 235 of sanding the uppermost coat of toner (e.g., the second coat of toner applied in task 225) after it is dried in task 230. In one or more embodiments, the task 235 of sanding the second coat of toner may be performed utilizing sandpaper having any suitable grid, such as 320 grit. Wood dust generated in task 235 may be blown off the wood product with compressed air.

In the illustrated embodiment, the method 200 also includes a task 240 of applying a glazing or a glaze coat to the uppermost coat of toner (e.g., the second coat of toner applied in task 225) after it has been sanded in task 235. The task 240 of applying the glaze coat may be performed in any suitable manner, such as manually applying the glaze coat by hand utilizing a cotton cloth. In one or more embodiments, the task 240 of applying the glaze includes partially removing glaze in the cross-grain direction of the wood veneer product and leaving some glaze on the wood veneer product (i.e., leaving glaze in the pores of the wood veneer product). The task 240 may also allowing the glaze to at least partially dry (e.g., allowing the glaze to set for approximately 5 to approximately 10 minutes, depending on weather conditions such as temperature and humidity). Once the glaze has set enough for the glaze to remain (i.e. hang up) in the pores of the wood veneer product, the task 240 may include re-applying the glaze to “re-activate” the glaze, which will make it easier to remove the excess glaze. The excess glaze may then be removed by hard wiping the upper surface of the wood veneer product and changing cotton cloths frequently. In one or more embodiments, the glazing (or glaze layer) applied in task 240 may be a combination of an aromatic hydrocarbon mixture >C9 (approximately 31% to approximately 52% by weight), isobutyl alcohol (approximately 12% to approximately 27% by weight), naphthalene (approximately 1.7% to approximately 4% by weight), n-butyl alcohol (approximately 1.7% to approximately 4% by weight), titanium dioxide (approximately 0.2% to approximately 3% by weight), cumene (approximately 0.1% to approximately 1.8% by weight), n-methyl-2-pyrrolidone (approximately 0.1% to approximately 1.8% by weight), silica (amorphous) (approximately 0.0% to approximately 0.4% by weight), a Stoddard solvent (approximately 0.0% to approximately 0.4% by weight), and aliphatic (light hydrocarbon solvent) (approximately 0.0% to approximately 0.4% by weight).

In the illustrated embodiment, the method 200 also includes a task 245 of drying the glaze coat applied in task 240. The task 245 of drying the glaze coat may be performed by air drying the glaze coat (i.e., drying the glaze coat at ambient conditions) for a duration in the range from approximately 4 hours to approximately 8 hours.

In the illustrated embodiment, the method 200 also includes a task 250 of post-processing the glaze coat after it has been dried in task 245. The task 250 of post-processing the glaze coat may include rubbing the glaze coat with steel wool or other abrasive, such as a fibrous pad (e.g., a fine mesh) formed of silicon carbide. In one or more embodiments, the method 200 may not include the task 250 of post-processing the glaze coat. The task 250 of post-processing the glaze coat is configured to produce a clear, color-rich finish.

In the illustrated embodiment, the method 200 includes a task 255 of applying a topcoat to the glaze coat after it has been dried in task 245 and (optionally) post-processed in task 250 to complete the stained wood product. In one or more embodiments, the task 255 of applying the topcoat may be performed within approximately 4 hours to approximately 8 hours after applying the glaze (or glaze coat) in task 240.

Following completion of the stained wood product, the stained wood product may be incorporated into a dwelling (e.g., an apartment or other living quarters), a commercial building (e.g., on the walls and/or the ceiling of a hotel room or an office building), and/or a transportation vehicle (e.g., on the walls, the ceiling, and/or the bulkheads of an aircraft cabin, the walls of an aircraft lavatory, and/or the walls of an aircraft galley).

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures can be practiced without meaningfully departing from the principles, spirit, and scope of this invention, as set forth in the following claims. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween.

What is claimed is:

1. A method of staining a wood product, the method comprising:
sanding a surface of the wood product;
wire brushing the surface to expose open grains in the wood product;
applying a first coat of a toner to the surface of the wood product, the first coat of the toner penetrating into the open grains of the wood product;
applying a second coat of the toner to the surface of the wood product after applying the first coat;
applying a glaze to the surface of the wood product after applying the second coat of the toner; and
applying a top coat to the surface of the wood product after applying the glaze.

2. The method of claim 1, further comprising drying the first coat of the toner for approximately 45 minutes before applying the second coat of the toner.

3. The method of claim 2, further comprising drying the second coat of the toner for approximately 45 minutes before applying the glaze.

4. The method of claim 3, further comprising sanding the second coat of the toner before applying the glaze.

5. The method of claim 4, further comprising drying the glaze for a duration in a range from 4 hours to 8 hours before applying the top coat.

6. The method of claim 5, further comprising post-processing the glaze after the drying of the glaze.

7. The method of claim 6, wherein the post-processing of the glaze comprises rubbing the glaze with an abrasive.

8. The method of claim 1, wherein the applying the glaze comprises:
partially removing the glaze in a cross-grain direction of the wood product and leaving the glaze in the open grains of the wood product;
allowing the glaze to set;
re-applying the glaze; and
removing excess of the glaze.

9. The method of claim 1, wherein the sanding the surface of the wood product utilizes a 150 grit sandpaper.

10. A stained wood product comprising:
a wood veneer having open grains exposed on a first surface of the wood veneer;
a first toner coating on the first surface of the wood veneer and in the open grains;
a second toner coating on the first toner coating;
a glaze on the second toner coating; and
a topcoat on the glaze.

11. A structure comprising the stained wood product of claim 10.

12. The structure of claim 11, wherein the structure is a wall in a hotel.

13. The structure of claim 11, wherein the structure is a wall in an aircraft.

14. The structure of claim 13, wherein the topcoat comprises a fire retardant.

15. The structure of claim 13, wherein the topcoat is a 4-part acrylic polyurethane topcoat comprising a fire retardant agent, a reducer, a low gloss clearcoat, and a low gloss clearcoat activator.

16. The structure of claim 11, wherein each of the first toner coating and the second toner coating comprises toluene, butyl acetate, acetone, isobutyl alcohol, ethyl alcohol, ethyl acetate, methanol, and propyl alcohol.

17. The structure of claim 16, wherein each of the first toner coating and the second toner coating further comprises n-butyl alcohol, isopropyl alcohol, and ethylbenzene.

18. The structure of claim 11, wherein the glaze comprises an aromatic hydrocarbon mixture having more than nine carbons (>C9), isobutyl alcohol, naphthalene, n-butyl alcohol, and titanium dioxide.

19. The structure of claim 11, wherein the topcoat comprises a first component, a catalyst, and a thinner.
